(19) United States
(12) Patent Application Publication
(10) Pub. No.: US 2008/0177627 A1
(43) Pub. Date: Jul. 24, 2008

(54) ELECTRONIC ADVERTISEMENT DELIVERY SYSTEM AND METHOD

(75) Inventor: Bob Cefail, Palm Harbor, FL (US)

Correspondence Address: MENDELSOHN AND ASSOCIATES, P.C., 1500 JOHN F. KENNEDY BLVD., SUITE 405, PHILADELPHIA, PA, 19102, US

(73) Assignee: INTERNET GAMING AND MARKETING TECHNOLOGIES, LLC, Mullica Hill, NJ (US)

(21) Appl. No.: 11/772,449

(22) Filed: Jul. 2, 2007

Related U.S. Application Data
(60) Provisional application No. 60/817,984, filed on Jun. 30, 2006.

(51) Int. Cl. G06Q 30/00; G06Q 10/00

(52) U.S. Cl. 705/14

(57) ABSTRACT

In one implementation, the invention can be an ad-control system for a computer network further comprising a user system. The user system is adapted to generate a user-interactive computer-simulated graphical environment (CSGE) having at least one graphical representation of a product-related item. The user system enables a user to select the product-related item represented in the CSGE. If the user selects the product-related item, then the user system sends a first message to the ad-control system identifying the user and the selected product-related item. The ad-control system is adapted to receive the first message from the user system and transmit a second message to the user containing information corresponding to the product-related item. The first message is transmitted prior to termination of the generation of the CSGE by the user system. The second message is transmitted independently of the state of the CSGE after the selection of the product-related item.

### REFERENCE TO PROVISIONAL APPLICATION

This application claims the benefit of the filing date of U.S. provisional application No. 60/817,984 filed on Jun. 30, 2006 as attorney docket no. 1132.001, the teachings of which are incorporated herein by reference.

### BACKGROUND OF THE INVENTION

1. Field of the Invention

This invention relates generally to computer-simulated graphical environments (CSGEs), such as video games, and more particularly, to CSGEs wherein a CSGE-user can receive product and/or service information from a vendor.

2. Description of the Related Art

Computers can be used to simulate components and elements of a real or imaginary environment. The visual component of such a computer-simulated environment (CSE) is referred to herein as a computer-simulated graphical environment (CSGE). A CSGE can be presented to a user via a monitor, virtual-reality goggles, or any suitable device allowing the user to visually perceive the CSE. Typically, speakers are used in conjunction with the CSGE to allow the user to aurally perceive the CSE. In addition, other devices may be used to allow the user to perceive the CSE using other senses.

A role-playing video game, for example, generates a CSGE in which the player, or CSGE-user, interacts with graphical elements in the CSGE as part of playing the video game. Whether the CSGE attempts to represent a real environment, such as the city of Philadelphia, or an imaginary environment, such as an alien city on the planet Mars, opportunities and incentives abound for commercial advertising in the CSGE. Typical CSGE advertisements include (i) billboards, posters, or similar advertisements, wherein the advertisement is graphically represented as part of CSGE and (ii) product placement, wherein a product is graphically represented in the CSGE, e.g., as a can of a particular brand of cola. Reasons for CSGE producers to insert commercial advertisements in a CSGE include (i) receiving revenue from the advertisers, (ii) providing a more realistic environment for players that includes real brands of products, and (iii) exposing players to brands and products about which they may want to learn more.

Several prior-art disclosures provide systems and methods for incorporating advertising into video games. These prior-art systems typically interrupt game play to (i) present advertising information to the player or (ii) allow the player to purchase the advertised product. Many players find such interruptions annoying. Some prior-art systems provide passive ads wherein ads or products are visually presented to a CSGE user, who, however, might or might not pay attention to the ad or product. Many advertisers are unenthusiastic about such passive ads in a CSGE since such passive ads do not indicate the level of user interest in the product as a result of the ads. What is needed is a novel interaction method and system for a product vendor and a user of a CSGE.

### SUMMARY OF THE INVENTION

One embodiment of the present invention can be a ad-control system for a computer network further comprising a user system, wherein (1) the user system is adapted to generate a user-interactive computer-simulated graphical environment (CSGE) having at least one graphical representation of a product-related item, wherein (i) the user system enables a user to select the product-related item represented in the CSGE and (ii) if the user selects the product-related item, then the user system sends a first message to the ad-control system identifying the user and the selected product-related item and (2) the ad-control system is adapted to receive the first message from the user system and transmit a second message to the user containing information corresponding to the product-related item, wherein (i) the first message is transmitted prior to termination of the generation of the CSGE by the user system, (ii) the second message is transmitted independently of the state of the CSGE after the selection of the product-related item, and (iii) the selection of the product-related item does not include the transmission of the second message.

Another embodiment of the present invention can be a user system for a computer network further comprising an ad-control system, wherein (1) the user system is adapted to generate a user-interactive computer-simulated graphical environment (CSGE) having at least one graphical representation of a product-related item, wherein (i) the user system enables a user to select the product-related item represented in the CSGE and (ii) if the user selects the product-related item, then the user system sends a first message to the ad-control system identifying the user and the selected product-related item and (2) the ad-control system is adapted to receive the first message from the user system and transmit a second message to the user containing information corresponding to the product-related item, wherein (i) the first message is transmitted prior to termination of the generation of the CSGE by the user system, (ii) the second message is transmitted independently of the state of the CSGE after the selection of the product-related item, and (iii) the selection of the product-related item does not include the transmission of the second message.

Yet another embodiment of the present invention can be a computer network comprising an ad-control system and a user system, wherein (1) the user system is adapted to generate a user-interactive computer-simulated graphical environment (CSGE) having at least one graphical representation of a product-related item, wherein (i) the user system enables a user to select the product-related item represented in the CSGE and (ii) if the user selects the product-related item, then the user system sends a first message to the ad-control system identifying the user and the selected product-related item and (2) the ad-control system is adapted to receive the first message from the user system and transmit a second message to the user containing information corresponding to the product-related item, wherein (i) the first message is transmitted prior to termination of the generation of the CSGE by the user system, (ii) the second message is transmitted independently of the state of the CSGE after the selection of the product-related item, and (iii) the selection of the product-related item does not include the transmission of the second message.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a system in accordance with one embodiment of the present invention.

FIG. 2 shows an exemplary flow chart for sample operation of the system of FIG. 1.

### DETAILED DESCRIPTION

Certain embodiments of the present invention can provide a seamless, immersive CSE experience for a user that allows the provision of potentially useful product information and/or offers. Certain embodiments of the present invention can also provide useful consumer-interest information to a product advertiser.

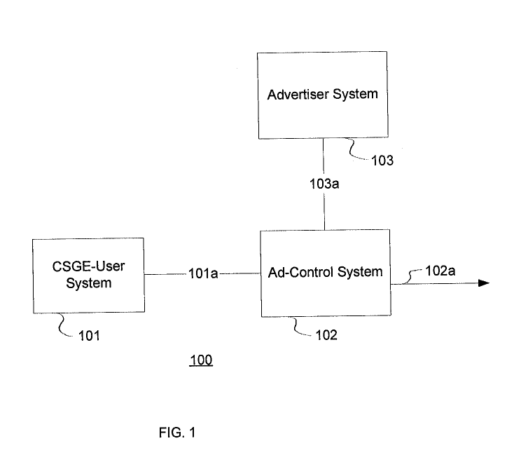

FIG. 1 shows computer network 100 in accordance with one embodiment of the present invention. Computer network 100 comprises CSGE-user system 101, ad-control system 102, and advertiser system 103. Advertiser system 103 is associated with a particular advertiser, and different advertisers can have their own advertiser systems (not shown) communicatively coupled to ad-control system 102. Similarly, CSGE-user system 101 is associated with a particular user, and different users can have their own CSGE-user systems (not shown). Ad-control system 102 functions as a central server for the one or more advertiser systems and the one or more CSGE-user systems.

CSGE-user system 101 comprises a computer that generates and presents a CSGE for a user (not shown). In certain implementations the CSGE is, for example, a role-playing video game, such as the Nightscape™ program from Nightlife Interactive, LLC of Clearwater, Fla. The CSGE of CSGE-user system 101 can be presented to the user through any suitable visual-information output device, such as a monitor, a projector, or virtual-reality goggles. The user can be represented in the CSGE by a full or partial avatar. A full avatar representation simulates a third-person viewpoint, wherein a full view of the user's avatar is presented. A partial avatar representation simulates a first-person viewpoint, wherein portions, such as limbs or tools, of the user's avatar may be presented, depending on the particular action of the avatar at a particular moment.

The user interacts with CSGE-user system 101 through one or more suitable input devices, such a mouse, a keyboard, a joystick, a game pad, a microphone (in conjunction with an appropriate system to convert spoken instructions to computer-comprehensible instructions), a motion-sensing glove, or other motion-sensing device. The user can use any suitable input device to select an item in the CSGE. For example, the user may use a mouse to click on an item to select the item. The user may right-click the item with the mouse to bring up a pop-up menu having several action choices. In certain embodiments, the user can use keyboard commands to pick up an object with the user's avatar's hand. In certain embodiments, the user can execute an input command to use a particular avatar tool to select the item, e.g., a command to fire a special weapon at the item or cast a special incantation with a magic wand. In certain embodiments, the possible uses of a selected item depend on various factors such as the nature of the selected item and the nature of the avatar. The nature of the avatar can be determined by, for example, avatar character type, avatar health, available avatar tools/resources, and user score.

CSGE-user system 101 visually presents a CSGE that includes, at a particular simulated location, at least one graphical representation of a product-related item, such as the product or an advertisement for the product. The location of the product-related item can be predetermined by the CSGE producer, or can be dynamically determined by CSGE-user system 101 based on appropriate factors. The nature of the product-related item is determined by CSGE-user system 101 based on various factors, such as preprogrammed information or dynamic instructions from ad-control system 102. Additional product-related items can be at other simulated locations in the CSGE not immediately visible to the user. Product-related items can be added, removed, or modified by CSGE-user system 101 in response to, for example, user actions, CSGE-user system 101 algorithms, or instructions from ad-control system 102.

In one exemplary implementation, if CSGE-user system 101 is representing a bar, then the CSGE can include a graphical representation of shelves holding multiple brands of vodkas and whiskeys. If, for example, brand A of vodka is associated in computer network 100 with advertiser A, then, if the user selects a bottle of brand A vodka using CSGE-user system 101, then a corresponding message is sent to ad-control system 102 via path 101a. The corresponding message is transmitted by CSGE-user system 101 in the background and the transmission has substantially no effect on the CSGE, which continues generation and presentation substantially uninterrupted.

In certain embodiments, CSGE-user system 101 provides minimally intrusive feedback confirming the selection of the bottle of brand A vodka. Such minimally intrusive feedback can include, for example, (i) a unique short sound, (ii) briefly altering the appearance of the selected bottle of brand A vodka, such as by the addition of a halo, or (iii) adding a representation of the selected bottle of brand A vodka to a satchel of avatar possessions. This feedback is not part of the product-related item selection. After the item is selected, game play continues seamlessly as before, with no, or minimal, interruption to the user. If the selected item is not associated in computer network 100 with any advertiser, then there is no need to send a corresponding message to ad-control system 102, and play also continues seamlessly.

The corresponding message that is sent to ad-control system 102 includes an identification of the user and of the selected product-related item. Ad-control system 102 maintains a database (not shown) that includes (i) contact information for the user, such as an email address (ii) contact information for the advertiser for the item, such as an email address, and (iii) an advertiser-authorized message, such as a coupon, for the selected item. After receiving the corresponding message, ad-control system 102 matches (i) the user identification to the user's contact information and (ii) the selected item to (a) the contact information for the advertiser and (b) the advertiser-authorized message for the selected item.

Ad-control system 102 generates and sends an email message including the advertiser-authorized message for the selected item to the user's email address via path 102a, which in certain embodiments connects to an appropriate network router, such as a network router that is part of the Internet, and in certain embodiments is the same as path 101a. The transmission of the email message including the advertiser-authorized message is not part of the selection of a product-related item by the user. Selection of a product-related item includes all of the steps performed by the user that are involved in the user selecting the product-related item, but does not include the generation and/or transmission of messages by ad-control system 102. Ad-control system 102 also generates and sends an email message, including identification of the user and the selected item, to the advertiser's email address at advertiser system 103, via path 103a. The internal processing performed by ad-control system 102 is invisible to CSGE-user system 101 which seamlessly continues with presentation of the CSGE after selection by the user of the selected item.

The particular advertiser-authorized message associated with a particular product-related item can be varied and/or replaced by advertiser system 103 via path 103a. Advertiser system 103 can provide several authorized messages for a product-related item to ad-control system 102, wherein ad-control system 102 selects the message to send the user based on algorithmic processing. Ad-control system 102 can keep track of the items selected by the user and select an advertiser-authorized message to send to the user based on the items previously selected by the user. For example, a customized message can be sent if the user previously selected a product of a competitor (not shown) of the advertiser of advertiser system 103. A different customized message can be sent if the user previously selected one or more products of the advertiser of advertiser system 103.

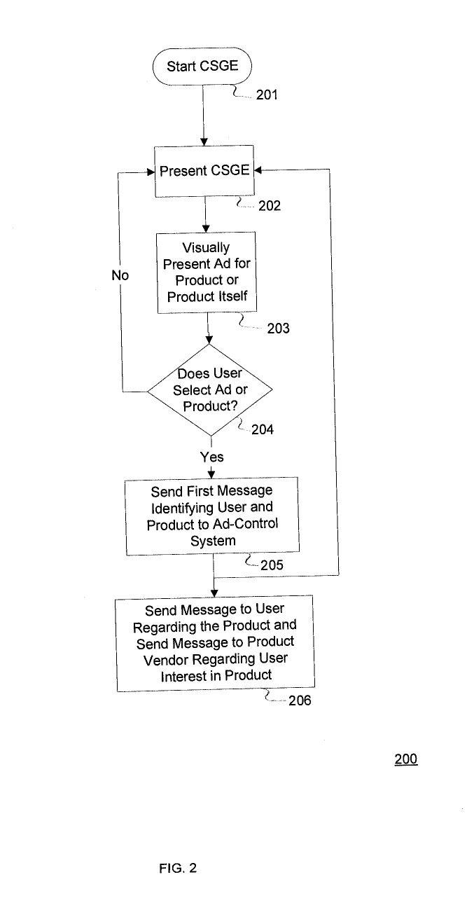

FIG. 2 shows exemplary flow chart 200 for sample operation of computer network 100 of FIG. 1. First, the CSGE is started (step 201), which results in generation and presentation of the CSGE via a suitable graphical output device (step 202). During presentation of the CSGE, at a time and place determined by the CSGE producers, algorithmically or by design, an ad for a product or the product itself is visually represented in the CSGE (step 203). If the user does not select the ad or product (step 204), then the process returns to step 202, wherein (i) the process can terminate with termination of the CSGE and (ii) if the process again proceeds to step 203, a different product or ad may be presented.

If the user selects the representation of the ad or product (step 204), then CSGE-user system 101 sends a first message identifying the user and product to ad-control system 102 (step 205) and substantially simultaneously returns to step 202. Then, after receiving the first message, ad-control system 102 sends a message to the user regarding the product and sends a message to the product vendor, i.e., advertiser, regarding the user's interest in the selected product (step 206). The transmission of the two email messages may be performed substantially in parallel (i.e., at substantially the same time, with the particular order unimportant). Following step 205, the ad-control system performs step 206 while CSGE-user system returns to step 202, wherein (i) the process can terminate with termination of the CSGE and (ii) if the process again proceeds to step 203, a different product or ad may be presented. The first message is sent before the CSGE is terminated. The second message is sent independently of the state of the CSGE after the selection of the ad or product. Thus, the ad-control system's transmission of the second message is not affected by whether the CSGE continues generation, is terminated, or is paused after the user selects the product.

In an alternative embodiment of computer network 100 of FIG. 1, the corresponding message sent by CSGE-user system 101 to ad-control system 102 in response to an appropriate item selection includes the contact information for the user. Thus, ad-control system 102 does not need to maintain a database correlating user identifications to user contact information.

If the user did not provide suitable contact information to an appropriate entity of computer network 100, then CSGE-user system 101 can ask for such information at a suitable stage, and, in certain embodiments, can halt continued operation unless such information is provided.

In an alternative embodiment of computer network 100 of FIG. 1, the contact information for the user is a cell-phone number, wherein the cell-phone is capable of receiving text messages and ad-control system 102 sends the advertiser-authorized message as a text or multimedia message to the cell-phone.

In one alternative embodiment of computer network 100 of FIG. 1, the message sent to advertiser system 103 is in a proprietary data format other than an Internet-deliverable email. Such a proprietary format may allow for more efficient transmission of data or greater transmission security. In another alternative embodiment, advertiser system 103 provides advertiser-authorized messages to ad-control system 102, but no messages regarding user interest in the advertiser's products are sent to advertiser system 103.

In one alternative embodiment of computer network 100 of FIG. 1, the information sent to advertiser system 103 by ad-control system 102 does not include identification of the user. In certain embodiments, the user can select whether ad-control system 102 includes user-identifying information in messages regarding the user sent to advertiser system 103.

The elements of computer network 100 of FIG. 1 are functional units and are not meant to represent a particular physical embodiment. The functional units can be implemented as a single, physically integrated system, as a physically distributed system, or as any suitable physical implementation. In one exemplary implementation, CSGE-user system 101 and ad-control system 102 can be integrated in a single tangible consumer product. In another exemplary implementation, ad-control system 102 can be implemented as a centralized server for multiple clients including one or more CSGE-user systems and one or more advertiser systems.

As used herein, and unless otherwise explicitly indicated, the term “product,” as well as any variants, refers to tangible items as well as intangible services.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing steps in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless explicitly stated otherwise, each numerical value and range should be interpreted as being approximate as if the word “about” or “approximately” preceded the value of the value or range. As used in this application, unless otherwise explicitly indicated, the term “connected” is intended to cover both direct and indirect connections between elements.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

We claim:

1. An ad-control system for a computer network further comprising a user system, wherein:
the user system is adapted to generate a user-interactive computer-simulated graphical environment (CSGE) having at least one graphical representation of a product-related item, wherein:
the user system enables a user to select the product-related item represented in the CSGE; and
if the user selects the product-related item, then the user system sends a first message to the ad-control system identifying the user and the selected product-related item; and
the ad-control system is adapted to receive the first message from the user system and transmit a second message to the user containing information corresponding to the product-related item, wherein:
the first message is transmitted prior to termination of the generation of the CSGE by the user system;
the second message is transmitted independently of the state of the CSGE after the selection of the product-related item; and
the selection of the product-related item does not include the transmission of the second message.

2. The system of claim 1, wherein the ad-control system is further adapted to transmit to an advertiser system of the computer network a third message identifying the user.

3. The system of claim 2, wherein the third message further identifies a product corresponding to the product-related item.

4. The system of claim 1, wherein the ad-control system is further adapted to transmit a third message to one of a plurality of advertiser systems, wherein the third message identifies at least one of the user and the product-related item.

5. The system of claim 1, wherein the ad-control system comprises a database that maintains contact information of an advertiser and correlates the advertiser contact information with the identification of the selected product-related item in the first message.

6. The system of claim 1, wherein:
the computer network further comprises an advertiser system; and
the content of the second message is determined by the advertiser system.

7. The system of claim 1, wherein the ad-control system is adapted to customize the content of the second message based on previous selections by the user of one or more other product-related items.

8. The system of claim 1, wherein the ad-control system is further adapted to transmit to an advertiser a third message disclosing the selection of the product-related item by the user without identifying the user.

9. The system of claim 1, wherein the product-related item is one of a product and an advertisement for the product.

10. The system of claim 1, wherein:
the CSGE has representations of a plurality of product-related items;
a subset of the plurality of product-related items are visible to the user at any one time in the CSGE; and
the ad-control system determines which subset of the plurality of product-related items is visible at any one time in the CSGE.

11. The system of claim 1, wherein the ad-control system comprises a database that maintains contact information for the user and correlates the contact information with the identification of the user in the first message.

12. The system of claim 1, wherein the first message contains contact information for the user.

13. The system of claim 1, wherein, if the user selects the product-related item, then the user system modifies, independently of the first message, the CSGE to indicate the selection of the product-related item.

14. The system of claim 1, wherein, if the user selects the product-related item and the user system lacks sufficient information to identify the user, then the user system requests the missing information from the user.

15. The system of claim 1, wherein the ad-control system and the user system are implemented on a single computer platform.

16. A user system for a computer network further comprising an ad-control system, wherein:
the user system is adapted to generate a user-interactive computer-simulated graphical environment (CSGE) having at least one graphical representation of a product-related item, wherein:
the user system enables a user to select the product-related item represented in the CSGE; and
if the user selects the product-related item, then the user system sends a first message to the ad-control system identifying the user and the selected product-related item; and
the ad-control system is adapted to receive the first message from the user system and transmit a second message to the user containing information corresponding to the product-related item, wherein:
the first message is transmitted prior to termination of the generation of the CSGE by the user system;
the second message is transmitted independently of the state of the CSGE after the selection of the product-related item; and
the selection of the product-related item does not include the transmission of the second message.

17. A computer network comprising an ad-control system and a user system, wherein:
the user system is adapted to generate a user-interactive computer-simulated graphical environment (CSGE) having at least one graphical representation of a product-related item, wherein:
the user system enables a user to select the product-related item represented in the CSGE; and
if the user selects the product-related item, then the user system sends a first message to the ad- control system identifying the user and the selected product-related item; and
the ad-control system is adapted to receive the first message from the user system and transmit a second message to the user containing information corresponding to the product-related item, wherein:
the first message is transmitted prior to termination of the generation of the CSGE by the user system;
the second message is transmitted independently of the state of the CSGE after the selection of the product-related item; and
the selection of the product-related item does not include the transmission of the second message.

18. The system of claim 17, wherein the computer network comprises multiple independent instances of the user system, wherein each instance corresponds to a different user.
